(19) United States
(12) Patent Application Publication
(10) Pub. No.: US 2003/0210205 A1
(43) Pub. Date: Nov. 13, 2003

(54) Intentional helix mode feedline radiation

(75) Inventors: Thomas P. Cencich, Littleton, CO (US); Julie A. Huffman, Highlands Ranch, CO (US); Jason B. Burford, Arvada, CO (US)

Correspondence Address: MICHAEL BEST & FRIEDRICH, LLP, 100 E WISCONSIN AVENUE, MILWAUKEE, WI, 53202, US

(73) Assignee: Lockheed Martin Corporation, Bethesda, MD (US)

(21) Appl. No.: 10/140,961

(22) Filed: May 8, 2002

(51) Int. Cl. H01Q 1/36; H01Q 21/00

(52) U.S. Cl. 343/895; 343/853

(57) ABSTRACT

A spiral antenna system that is designed to have an increased upper frequency limit. The system includes a spiral antenna element having a feed end, and a helical antenna element having a helical portion electrically interconnected with the feed end of the spiral antenna element. In one embodiment, the helical antenna element comprises a coaxial cable having a portion of the outer conductor removed (e.g., tapered). For example, the helical antenna element could comprise a portion of the feedline that follows a substantially helical path. Preferably, the spiral antenna element defines a spiral axis, and the helical antenna element defines a helical axis substantially aligned with the spiral axis. The helical antenna element can be spaced from the helical axis a distance less than or equal to the radial distance of the feed end of the spiral antenna.

### BACKGROUND OF THE INVENTION

The present invention relates to antennas, and specifically to feedlines for spiral antennas.

Spiral antennas are well known for being able to transmit and receive signals consistently over a wide range of frequencies. Typically, traditional spiral antennas operate over a 10:1 bandwidth, meaning the upper frequency limit of the antenna is approximately ten times that of the lower frequency limit. In traditional spiral antennas, the upper and lower frequency limits are highly dependent on the inner and outer radii of the spiral, respectively. The circumference or fineness of the spiral center determines the upper frequency limit.

Manufacturing a spiral antenna to operate at millimeter wave frequencies (the frequencies in the range of about 18 GHz to about 60 GHz) becomes increasingly difficult because the upper frequency limit is so dependent upon the fineness of the spiral. The manufacturing tolerances on the spiral surface continue to diminish as cost for manufacturing grows.

### SUMMARY OF THE INVENTION

The present invention provides a spiral antenna system that is designed to have an increased upper frequency limit. More specifically, the system includes a spiral antenna element having a feed end, and a helical antenna element having a helical portion electrically interconnected with the feed end of the spiral antenna element. In one embodiment, the helical antenna element comprises a coaxial cable having a portion of the outer conductor removed (e.g., tapered). For example, the helical antenna element could comprise a portion of the feedline that follows a substantially helical path. Preferably, the spiral antenna element defines a spiral axis, and the helical antenna element defines a helical axis substantially aligned with the spiral axis. The helical antenna element can be spaced from the helical axis a distance less than or equal to the radial distance of the feed end of the spiral antenna.

Other features and advantages of the invention will become apparent by consideration of the detailed description and accompanying drawings.

### BRIEF DESCRIPTION OF THE DRAWINGS

FIG. 1 is a plan view of a spiral antenna embodying the present invention.

FIG. 2 is a side view of the spiral antenna as shown in FIG. 1.

FIG. 3 is a perspective view of an alternative feed structure.

FIG. 4 is a perspective view of a plurality of feedlines included in a feed structure embodying the invention.

FIG. 5 is a cross-sectional view of the plurality of feedlines shown in FIG. 4, taken along line 5-5.

FIG. 6 is a graph illustrating the predicted relationship between the upper frequency limit of a spiral antenna to the diameter of the feedline.

FIG. 7 is a plan view of a broadband antenna system incorporating the spiral antenna as shown in FIG. 1

FIG. 8 is a side view of the broadband antenna system as shown in FIG. 7, taken along line 8-8.

FIG. 9 is a side view of a second embodiment of the present invention.

FIG. 10 is a side view of a third embodiment of the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

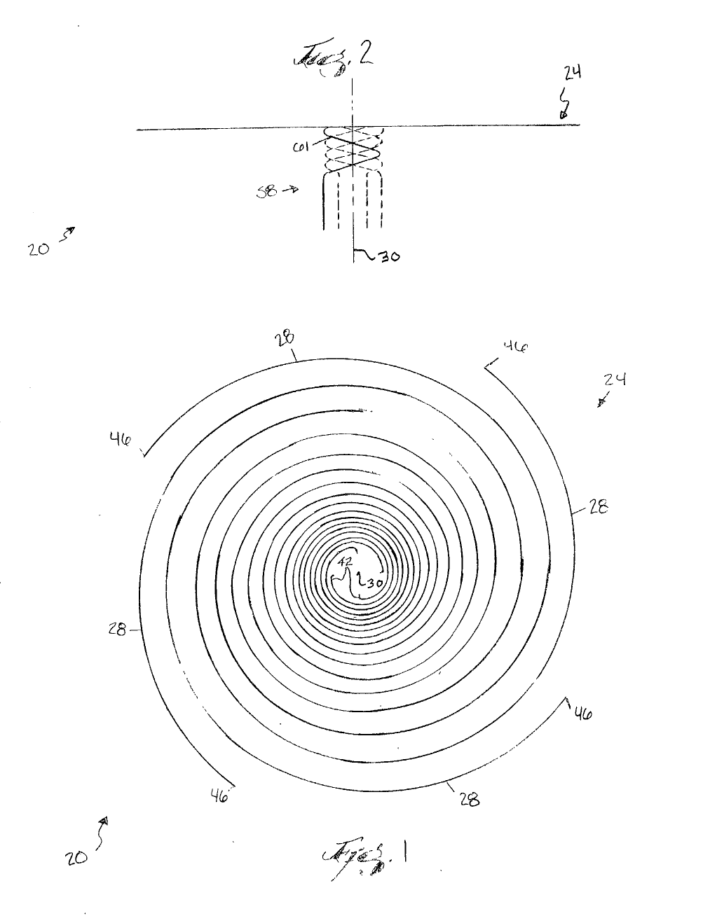

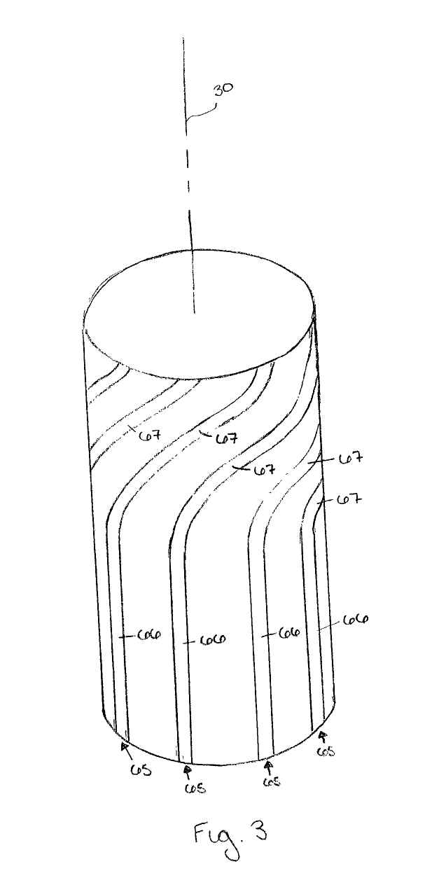

A broadband antenna system 20 embodying the invention is illustrated in FIGS. 1-7. The antenna system 20 includes a spiral antenna 24 having a plurality of spiral antenna elements or arms 28 defining a spiral axis 30. In the embodiment shown, the antenna 24 is a planar equiangular spiral antenna and has four spiral arms 28. In other embodiments, the antenna 24 can be an Archimedean spiral, a sinuous antenna, a log-periodic antenna or other antennas from the traveling wave or frequency independent antenna class. The antenna 24 can also include more or fewer arms 28 than the embodiment shown in FIGS. 1-2. Each spiral arm 28 has a first or feed end 42 and a second or outside end 46. The feed end 42 is spaced a radial distance from the spiral axis 30. In other embodiments, the outside end 46 of each spiral arm is connected to additional electronics or circuitry, or connected to an electrical load.

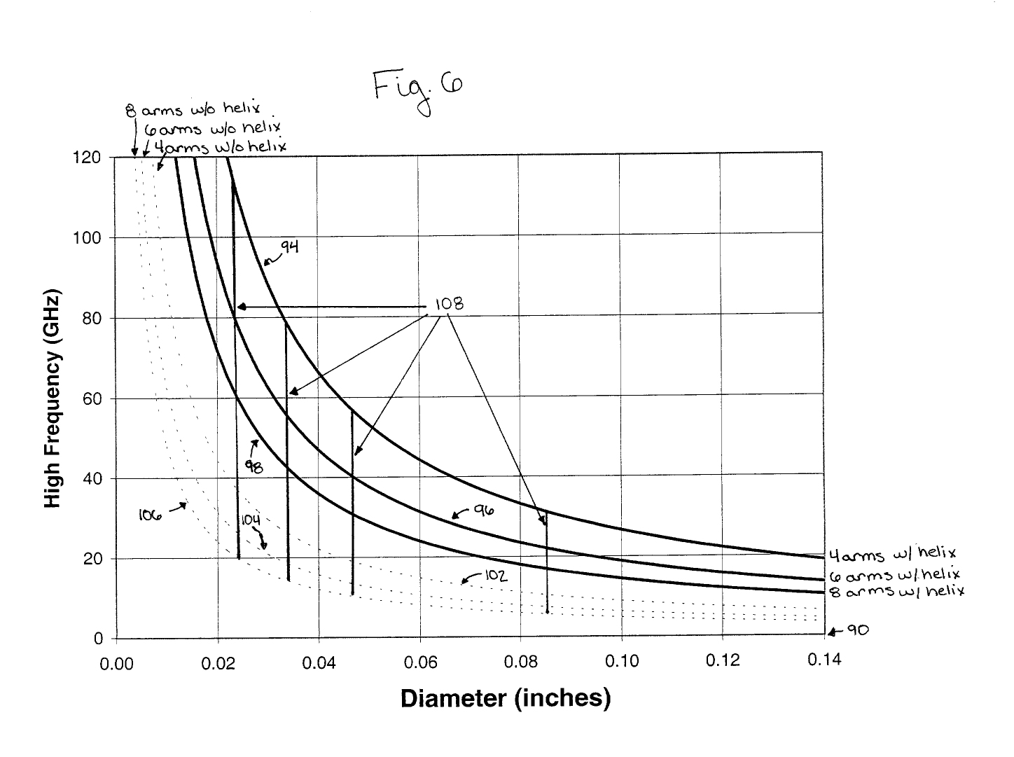

The antenna system 20 also includes a feed structure 58 having a plurality of helical feedlines 61-64 that define a helical axis, which in the illustrated embodiment is aligned with the spiral axis 30. In other embodiments, the feed structure 58 includes a plurality of feedlines that take the form of a conical helix. The feedlines 61-64 electrically connect the plurality of spiral arms 28 to a receiving or transmitting network (not shown). In the present invention, the feed structure 58 includes the same number of feedlines as the number of arms 28 in the spiral antenna 24. For the spiral antenna 24 illustrated in FIG. 1, the feed structure 58 includes four helical feedlines 61-64. For illustrative purposes, only one feedline 61 is shown in FIG. 2 in solid line. The other three feedlines 62-64 are shown in dashed lines and are not labeled. All of the feedlines 61-64 are illustrated and labeled in FIG. 5. The feedlines shown in FIG. 2 form a helix having one turn. In other embodiments, the helical feedlines 61-64 can include more or fewer turns.

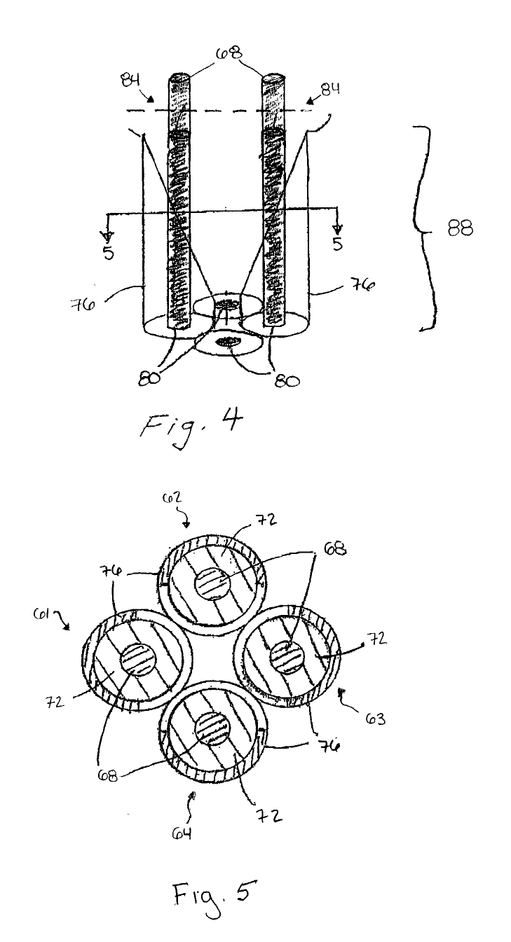

FIG. 3 illustrates another feed structure having eight feedlines 65. The feedlines each include a straight portion 66 and a helical portion 67. In this embodiment, the helical portions each travel about one quarter of a turn. At least part of the helical portions 67 is unshielded so that the feedlines 65 can transmit and/or receive signals. The straight portions 66 can remain shielded. In this manner, the helical portions 67 essentially act as a miniature helical antenna element. The helical portions 67 are spaced from the axis 30 approximately the same distance as the feed ends 42.

The unshielding of the helical portions of the feedlines is illustrated in FIGS. 4 and 5. The feedlines 61-64 are preferably configured from coaxial transmission line. In other embodiments, the feedlines could be configured from microstrip transmission line or a similar transmission line. Referring to FIGS. 4 and 5, each feedline 61-64 includes an inner conductor 68, a dielectric layer 72 and an outer conductor 76. For ease of explanation, the feedlines 61-64 shown in FIGS. 4 and 5 are not arranged in a helix. The dielectric layer 72 surrounds the inner conductor 68, and the outer conductor 76 surrounds the dielectric layer 72. Each feedline 61-64 further includes a bottom end or input end 80, a top end or output end 84, and a transition section 88 found between the input end 80 and the output end 84. The feedlines 61-64 are in a substantially uncoupled state at each of the input ends 80. At the output ends 84, the feedlines 61-64 are in a highly coupled state. The transition between the uncoupled state to the highly coupled state takes place during the transition section 88. The outer conductor 76 of each feedline 61-64 is tapered in a manner such that the transition from one state to the other is smooth. The outer conductor 76 can be tapered linearly, exponentially or another manner that allows the states to transition smoothly. The illustrated tapering starts on the inside (i.e., the side facing the other feedlines) and moves toward the outside, but could instead be outside to inside or side to side. The dielectric layer 72 can also be tapered in the same fashion as the outer conductor 76, tapered in a different manner than the outer conductor 76, or not tapered at all.

Tapering the feedlines 61-64 allows each feedline 61-64 to transition from a substantially uncoupled state at the input end 80 to a highly coupled state at the output end 84. Having the feedlines 61-64 in a coupled state allows the feed structure 58 to better match the antenna input impedance to the feedline impedance, and can simultaneously match multiple antenna modes having different modal impedances. Also, at the output end or highly coupled end 84, each feedline 61-64 is able to radiate when excited because the feedlines 61-64 are unshielded. It is believed that a helical feedline can increase the upper frequency limit of a spiral antenna 24 by a factor of two, allowing the antenna 24 to operate in the millimeter-wave frequency region.

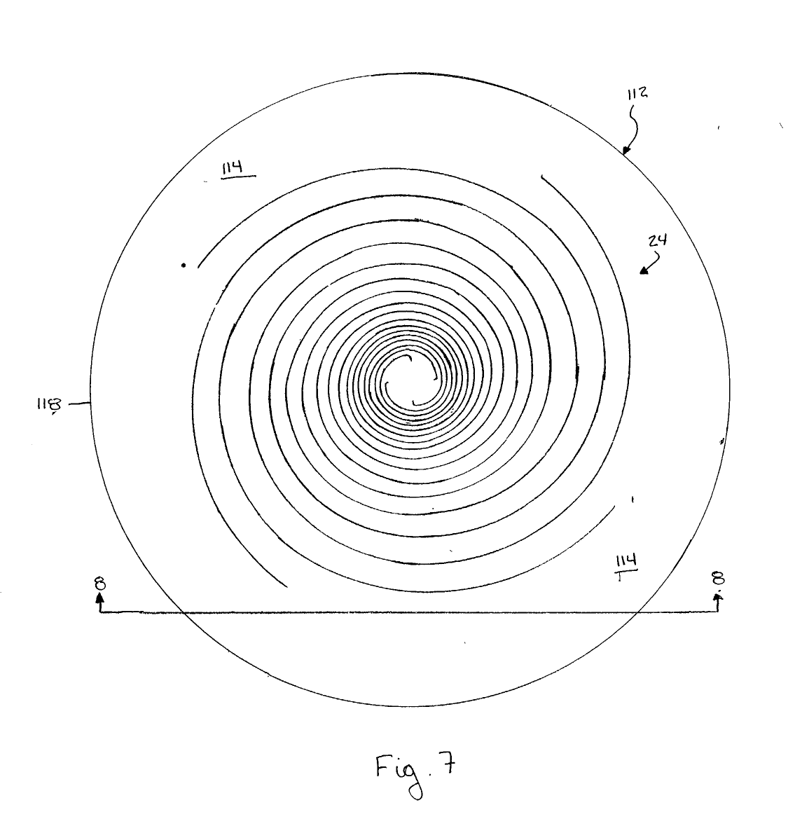

The diameter of the helical feedline and the number of antenna elements or arms both become a factor in determining the upper frequency limit of an antenna. The graph shown in FIG. 6 illustrates the predicted relationship between the upper frequency limit and the diameter of the feedline for various multi-element spiral antennas having a helical feed structure. The feedline diameter is represented on the x-axis 90 and the upper frequency limit is represented on the y-axis 92. The first solid line 94 illustrates the relationship for a spiral antenna having four antenna elements, the second solid line 96 illustrates the relationship for a spiral antenna having six antenna elements, and the third solid line 98 illustrates the relationship for a spiral antenna having eight elements.

Still referring to FIG. 6, the dashed line 102, 104, and 106 illustrates the relationship between the upper frequency limit and the diameter of the feedline for various multi-element spiral antennas not including a helical feed structure. The first dashed line 102 illustrates the relationship for a spiral antenna having four antenna elements, the second dashed line 104 illustrates the relationship for a spiral antenna having six elements, and the third dashed line 106 illustrates the relationship for a spiral antenna having eight elements. The vertical lines 108 represent the diameters of commercially available or standard coaxial cable. As illustrated by the first solid line 94, a spiral antenna having four antenna elements can include a standard coaxial cable with a large diameter (such as 0.047 inches) for the helical feedline and have an upper frequency limit of approximately 60 GHz. As illustrated by the first dashed line 102, a spiral antenna having four antenna elements and not having the helical feed structure would have an upper frequency limit of approximately 20 GHz when using standard 0.047 in. coaxial cable for the feedlines.

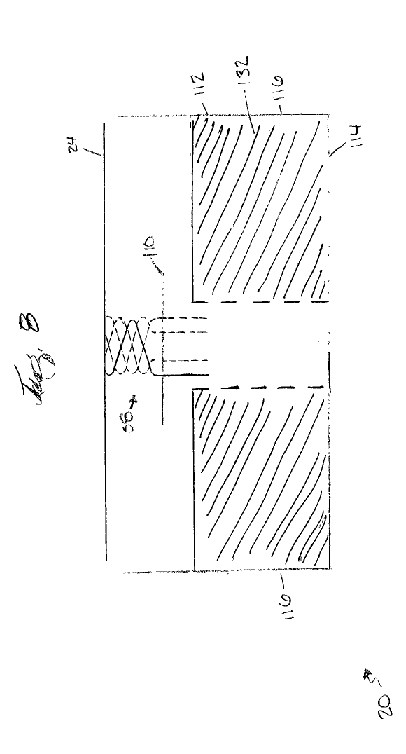

When the helical feedlines 61-64 are excited and start to radiate, the feedlines produce backfire radiation. In other words, the helical feedlines radiate in the opposite direction. As the number of turns in the helix increases, the directivity of the back lobe or rear beam increases and causes the front-to-back ratio (the ratio of the maximum directivity of an antenna to its directivity in a specified rearward direction) to decrease. Therefore, in one embodiment, the helical feedlines have approximately one quarter of a turn and a reflective element 110 (FIG. 8) is positioned beneath the helical feedlines to reflect the backfire radiation. The reflective element 110 is a metallic disc with an opening (not shown) or a series of openings (not shown) for the helical feedlines to pass through. In other embodiments, the reflective element 110 can vary in shape and size and can be configured from other materials with reflective properties.

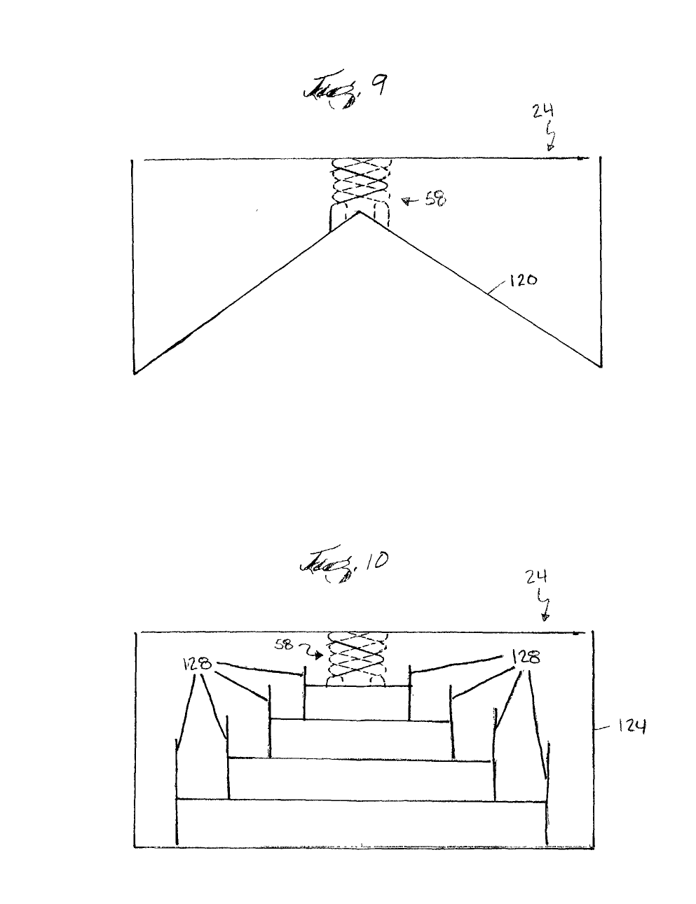

The antenna system 20 can also include a reflective cavity 112. When a planar spiral antenna radiates, it typically produces equal radiation above and below the antenna. In order to produce one beam of radiation, the reflective cavity 112 is positioned substantially beneath the spiral antenna 24. As shown in FIGS. 7 and 8, the reflective cavity 112 substantially surrounds the helical feedlines 61-64 and reflective element 110. The cavity 112 includes a reflective base 114 and sidewall 118. In other embodiments, the cavity 112 can vary in shape and size and include more or less sidewalls 118. The cavity 112 can further include a single reflective base 114 of varying shape and size, such as a conical base 120, shown in FIG. 9, or include a stepped base cavity 124, shown in FIG. 10, with or without the additional inner side walls 128. Also, the reflective base 114 can be substantially parallel to the spiral antenna 24 or not. In the embodiment of FIG. 8, a radio frequency absorber 132 is positioned within the reflective cavity 112 to avoid reflections that could degrade the antenna patterns over wide bandwidths. The absorber 132 can included one or more layers of a foam absorber, a honeycomb absorber, and/or a loaded material, as is known in the art. Typically, in the embodiments when the reflective base 114 is shaped, such as shown in FIGS. 9 and 10, the absorber 132 is not used. A layer or multiple layers of unloaded foam or honeycomb (not shown), in some embodiments, may be placed within the reflective cavity 112 to support the spiral antenna 24 and the reflective element 110.

Various features and advantages of the invention are set forth in the following claims.

What is claimed is:

1. An antenna system comprising:
an antenna element adapted to send or receive a signal; and a feedline having an output end electrically connected to the antenna element, wherein the feedline includes a helical portion that follows a helical path.

2. The antenna as set forth in claim 1, wherein the antenna element is a spiral antenna defining a spiral axis and includes a feed end spaced a radial distance from the spiral axis, and wherein the helical portion defines a helical axis substantially aligned with the spiral axis.

3. The antenna as set forth in claim 2, wherein the helical portion is spaced from the helical axis a distance less than or equal to the radial distance.

4. The antenna as set forth in claim 1, wherein the helical portion is approximately one quarter of a turn.

5. The antenna as set forth in claim 1, wherein at least a portion of the helical portion is unshielded.

6 The antenna as set forth in claim 1, wherein the feedline comprises a tapered coaxial transmission line having an uncoupled part, a highly coupled part, and a transition section located between the uncoupled part and highly coupled part.

7. The antenna as set forth in claim 1, further comprising a reflective element positioned beneath the helical portion.

8. The antenna as set forth in claim 7, further comprising a reflective cavity substantially surrounding the helical portion and reflective element.

9. The antenna as set forth in claim 8, further comprising a radio frequency absorber is positioned within the reflective cavity.

10. An antenna system comprising:
a spiral antenna element having a feed end; and
a helical antenna element having a helical portion electrically interconnected with the feed end of the spiral antenna element.

11. The antenna system set forth in claim 10, wherein the helical antenna element comprises a coaxial cable having an inner conductor and an outer conductor, wherein at least a portion of the outer conductor is removed.

12. The antenna system set forth in claim 11, wherein at least a portion of the coaxial cable is tapered.

13. The antenna system set forth in claim 10, wherein the spiral antenna element defines a spiral axis and includes a feed end spaced a radial distance from the spiral axis, and wherein the helical antenna element defines a helical axis substantially aligned with the spiral axis.

14. The antenna system set forth in claim 13, wherein the helical antenna element is spaced from the helical axis a distance less than or equal to the radial distance.

15. A method of transmitting a signal using an antenna element and a feedline electrically interconnected with the antenna element, the method comprising:
exciting the antenna element with a signal within a first frequency band; and
exciting the feedline with a signal within a second frequency band, the second frequency band being higher than the first frequency band.

16. The method as set forth in claim 15, wherein the feedline includes a helical portion that follows a helical path, and wherein exciting the feedline includes exciting the helical portion.

17. The method as set forth in claim 15, wherein a portion of the feedline is unshielded, and wherein exciting the feedline includes exciting the unshielded portion.

18. The method as set forth in claim 17, wherein the feedlines radiate as a helical antenna array.
